(19) United States
(12) Patent Application Publication
(10) Pub. No.: US 2014/0047238 A1
(43) Pub. Date: Feb. 13, 2014

(54) DEVICE IDENTIFICATION USING SYNTHETIC DEVICE KEYS

(71) Applicant: NetAuthority, Inc., Fremont, CA (US)

(72) Inventors: Talbot HARTY, Sutter Creek, CA (US); Dono HARJANTO, Irvine, CA (US); Karim KADDOURA, San Francisco, CA (US)

(21) Appl. No.: 13/922,605

(22) Filed: Jun. 20, 2013

Related U.S. Application Data
(60) Provisional application No. 61/682,096, filed on Aug. 10, 2012.

(30) Foreign Application Priority Data
Oct. 18, 2012 (AU) 2012101559

(51) Int. Cl. H04L 9/32

(52) U.S. Cl. CPC H04L 9/3236
USPC 713/168; 709/224

(57) ABSTRACT

A device authentication server assigns unique synthetic device attributes to a device such that the device can use actual hardware and system configuration attributes and the assigned synthetic device attributes to form a device identifier that is unique, even among homogeneous devices for which actual, accessible hardware and system configuration attributes are not distinct.

This application claims priority to U.S. Provisional Application No. 61/682,096, which was filed Aug. 10, 2012, and which is fully incorporated herein by reference.

### BACKGROUND OF THE INVENTION

1. Field of the Invention

The present invention relates generally to computer systems and, more particularly, to methods of and systems for uniquely identifying computing devices.

2. Description of the Related Art

Device identification through digital fingerprints has proven to be invaluable in recent years to such technologies as security and digital rights management. In security, authentication of a person can be restricted to a limited number of previously authorized devices that are recognized by their digital fingerprints. In digital rights management, use of copyrighted or otherwise proprietary subject matter can be similarly restricted to a limited number of previously authorized devices that are recognized by their digital fingerprints.

Digital fingerprints are particularly useful in uniquely identifying computing devices that are historically know as “IBM PC compatible”. Such devices have an open architecture in which various computer components are easily interchangeable with compatible but different components. There are two primary effects of such an open architecture that facilitate device identification through digital fingerprints.

The first facilitating effect is diversity of device components. Since numerous components of IBM PC compatible devices are interchangeable with comparable but different components, generation of a digital fingerprint from data associated with the respective components of the device are more likely to result in a unique digital fingerprint. For example, various hard disk drive models from various manufacturers can be included in IBM PC compatible computers, providing a diversity of possible configurations.

The second facilitating effect is discoverability of details of the various components of IBM PC compatible devices. Since the particular combination of components that make up a given device can vary widely and can come from different manufacturers, the components and the operating system of the device cooperate to provide access to detailed information about the components. Such information can include serial numbers, firmware version and revision numbers, model numbers, etc. This detailed information can be used to distinguish identical components from the same manufacturer and therefore improves uniqueness of digital fingerprints of such devices.

Laptop computing devices evolved from desktop computing devices such as IBM PC compatible devices and share much of the architecture of desktop computing devices, albeit in shrunken form. Accordingly, while users are much less likely to replace graphics circuitry in a laptop device and components therefore vary less in laptop devices, laptop devices still provide enough detailed and unique information about the components of the laptop device to ensure uniqueness of digital fingerprints of laptop devices.

However, the world of computing devices is rapidly changing. Smart phones that fit in one's pocket now include processing resources that were state of the art just a few years ago. In addition, smart phones are growing wildly in popularity. Unlike tablet computing devices of a decade ago, which were based on laptop device architectures, tablet devices available today are essentially larger versions of smart phones.

Smart phones are much more homogeneous than older devices. To make smart phones so small, the components of smart phones are much more integrated, including more and more functions within each integrated circuit (IC) chip. For example, while a desktop computing device can include graphics cards and networking cards that are separate from the CPU, smart phones typically have integrated graphics and networking circuitry within the CPU. Furthermore, while desktop and laptop devices typically include hard drives, which are devices rich with unique and detailed information about themselves, smart phones often include non-volatile solid-state memory, such as flash memory, integrated within the CPU or on the same circuit board as the CPU. Flash memory rarely includes information about the flash memory, such as the manufacturer, model number, etc.

Since these components of smart phones are generally tightly integrated and not replaceable, the amount and variety of unique data within a smart phone that can be used to generate a unique digital fingerprint is greatly reduced relative to older device architectures. In addition, since it is not expected that smart phone components will ever be replaced, there is less support for access to detailed information about the components of smart phones even if such information exists.

The iOS® operating system from Apple Computer of Cupertino, Calif., which is the operating system of Apple Computer's iPhone® smart phone and iPad® tablet device, denies access to much of the hardware configuration of those devices. Accordingly, generation of unique device identifiers from configuration attributes of these devices from Apple Computer is particularly difficult.

Accordingly, it is much more difficult to assure that digital fingerprints of smart phones and similar portable personal computing devices such as tablet devices are unique. What is needed is a way to uniquely identify individual devices in large populations of homogeneous devices.

### SUMMARY OF THE INVENTION

In accordance with the present invention, a device authentication server assigns unique synthetic device attributes to a device such that the device can use actual hardware and system configuration attributes and the assigned synthetic device attributes to form a device identifier that is unique, even among homogeneous devices for which actual, accessible hardware and system configuration attributes are not distinct.

During initial registration of a device with the device authentication server, the device provides attribute data representing numerous actual hardware and system configuration attributes of the device. The device authentication server generates a number of cryptographic keys using known pseudo-random number generation techniques and, for each of the keys, generates a cryptographic salt from various portions of the attribute data. By application of a cryptographic hash function to the cryptographic keys and the respective cryptographic salts, the device authentication server generates randomized attribute values based on actual attribute data of the device. Accordingly, the randomized attribute values have a high likelihood of being globally unique.

The device authentication server sends the randomized attribute values as synthetic attributes of the device. The device authentication server can also send the data specifying the precise manner in which the synthetic attributes are generated such that the device can re-generate the synthetic attributes from actual hardware and system configuration attributes of the device. Either way, the device authentication server provides the device with the ability to return the synthetic device attributes upon request.

For subsequent authentication of the device, the device sends data representing various parts of the device's actual hardware and system configuration attributes and synthetic attributes. The device authentication server sends a challenge that specifies the particular parts of the attributes to gather and the manner in which the parts are to be combined. The manner of combination can be a cryptographic hash function such that the device forms a cryptographic hash from the parts of the attributes. Since the attributes from which the parts are gathered include synthetic attributes assigned to the device by the device authentication server, the complete set of attributes of the device is unique among all devices, including very similar devices. In other words, when accessible hardware and system configuration attributes of homogeneous devices are inadequately to distinguish among such devices, the synthetic attributes provide distinguishing attributes.

The device authentication server receives the data representing various parts of the device's attributes, both actual and synthetic. The device authentication server can compare the received data to expected data. If the received data is a cryptographic hash, the device authentication server generates an expected hash by applying the same cryptographic hash to corresponding parts of the attribute data received during device registration and of the synthetic attributes previously generated for the device.

Accordingly, homogeneous devices can be distinguished and authenticated.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a computing device and a server and a device authentication server that cooperate to identify the device in accordance with one embodiment of the present invention.

FIG. 2 is a transaction flow diagram illustrating the manner in which the device and device authentication server of FIG. 1 cooperate to register the device for subsequent authentication.

FIG. 3 is a transaction flow diagram illustrating the manner in which the device, server, and device authentication server of FIG. 1 cooperate to authenticate the device.

FIG. 4 is a block diagram showing the server of FIG. 1 in greater detail.

FIG. 5 is a block diagram showing the device authentication server of FIG. 1 in greater detail.

FIG. 6 is a block diagram showing the device of FIG. 1 in greater detail.

FIG. 7 is a block diagram of synthetic device attributes generated by the device authentication server.

FIG. 8 is a block diagram of a known device record maintained by the device authentication server to facilitate device authentication in accordance with the present invention.

FIG. 9 is a logic flow diagram illustrating the generation of synthetic device attributes by the device authentication server.

### DETAILED DESCRIPTION

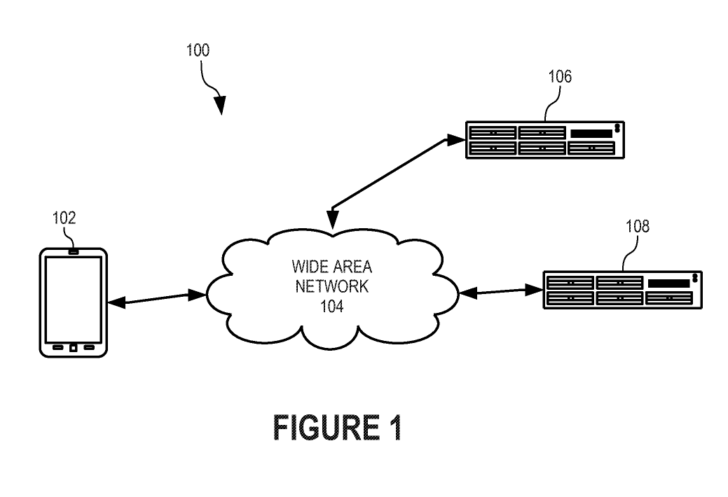

In accordance with the present invention, a computing device 102 (FIG. 1) is identified by a digital identifier incorporating a combination of hardware attributes of device 102 and synthetic attributes of device 102 generated for device 102 during registration with a device authentication server 108. Accordingly, device 102 can be distinguished from other computing devices that are not readily distinguished by hardware characteristics alone.

Device attributes and synthetic device attributes are described briefly to facilitate understanding and appreciation of the present invention. Known device data 800 (FIG. 8) includes device attributes 802, both of which are described in greater detail below. Each device attribute 802 includes a name 804 and a value 806. Examples of device attributes of device 102 include a serial number of a storage device within device 102 and detailed version information regarding an operating system executing within device 102. In the example of a serial number of a storage device, name 804 specifies the serial number of a given storage device (such as “C:” or “/dev/sda1”) as the particular information to be stored as value 806, and value 806 stores the serial number of the given storage device of device 102.

Device attribute 802 can also represent a synthetic device attribute. In such a case, name 804 is an identifier of a given synthetic device attribute, e.g., “Synth01”, and value 804 is a randomly generated data value that has a very high likelihood of being unique among all values for the same synthetic attribute for other devices. Thus, to authenticate device 102, device authentication server 108 can request both (i) device attributes such as the serial number of a storage device and (ii) synthetic attributes, e.g., by asking “what is the value associated with ‘Synth01’?” of device 102.

Device authentication system 100 includes device 102, a server 106, and a device authentication server 108 that are connected to one another through a wide area computer network 104, which is the Internet in this illustrative embodiment. Device 102 can be any of a number of types of networked computing devices, including smart phones, tablets, netbook computers, laptop computers, and desktop computers. Server 106 is a server that provides services to remotely located devices such as device 102 but that is required to authenticate device 102 prior to providing those services. Device authentication server 108 is a server that authenticates devices on behalf of other computers, such as server 106.

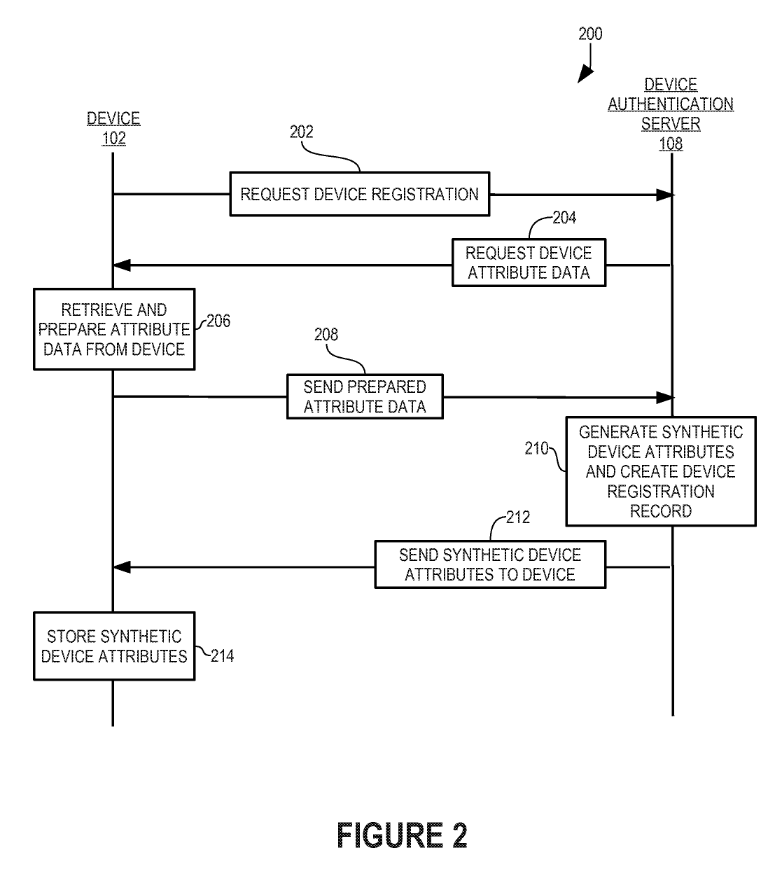

Transaction flow diagram 200 (FIG. 2) represents the manner in which device 102 registers itself with device authentication server 108 such that device 102 can be subsequently be authenticated.

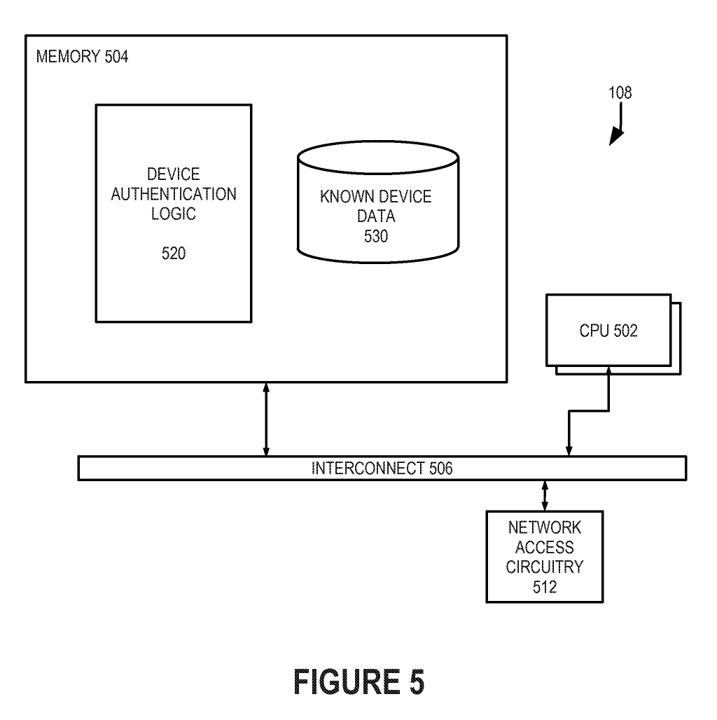

In step 202, device 102 sends a request for registration to device authentication server 108. The request can be in the form of a URL specified by the user of device 102 using a web browser 520 (FIG. 5) executing in device 102 and conventional user interface techniques involving physical manipulation of user input devices 508. Web browser 520 and user input devices 508 and other components of device 102 are described in greater detail below.

In step 204 (FIG. 2), device authentication server 108 sends a request to device 102 for device attributes of device 102.

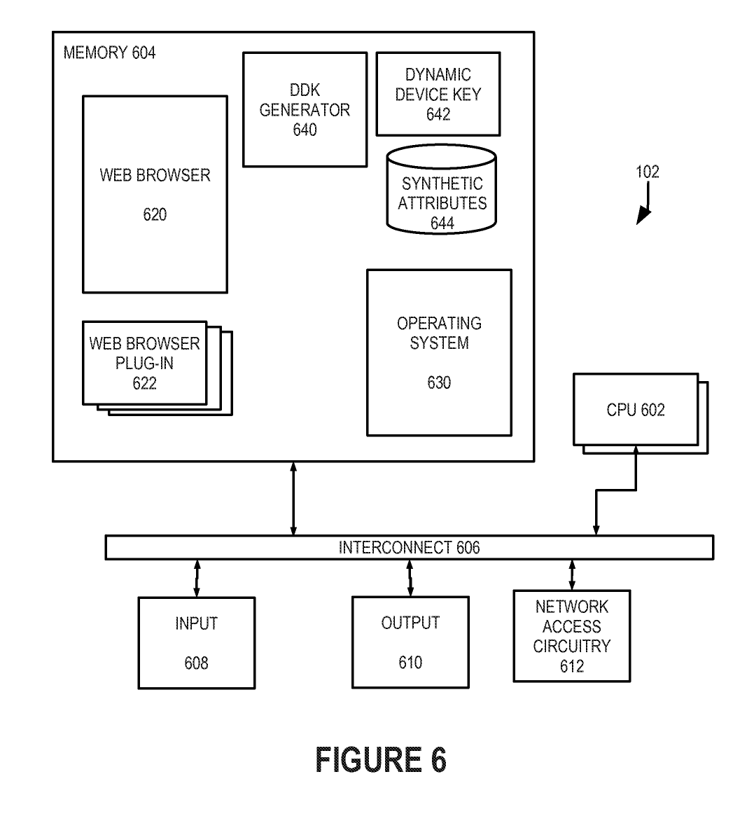

The request sent to device 102 includes content that causes web browser 620 (FIG. 6) of device 102 to gather attribute data representing hardware and other configuration attributes of device 102. In one embodiment, a web browser plug-in 622 is installed in device 102 and, invoked by web browser 620, processes the content of the web page to gather the attribute data in step 206. In other embodiments, the attribute data can be gathered by other forms of logic of device 102, such as DDK generator 640 installed in device 102. The various elements of device 102 and their interaction are described more completely below.

In this illustrative embodiment, web browser plug-in 622 or DDK generator 640 encrypts the attribute data using a public key of device authentication server 108 and public key infrastructure (PKI).

In step 208 (FIG. 2), device 102 sends the attribute data that was gathered in step 206 to device authentication server 108.

In step 210, device authentication logic 520 (FIG. 5) of device authentication server 108 creates a device registration record for device 102 and generates synthetic device attributes from the received attribute data.

Known device data 800 (FIG. 8) is a registration record and, in this illustrative example, represents registration of device 102. Known device data 800 includes a number of device attributes 802 which are described above. Briefly, each includes a name 804 specifying a particular type of information and a value 806 representing the particular value of that type of information from device 102. For example, if name 804 specifies a serial number of a given storage device, value 806 stores the serial number of that storage device within device 102. Synthetic key generation records 808 are described below.

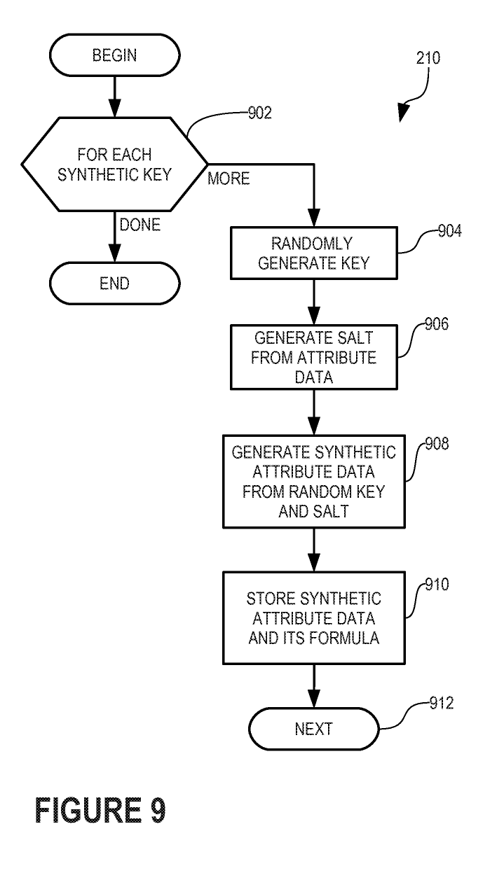

The manner in which device authentication logic 520 generates synthetic device attributes is shown in greater detail as logic flow diagram 210 (FIG. 9).

Loop step 902 and next step 912 define a loop in which device authentication logic 520 generates each of a number of synthetic attributes according to steps 904-910. In this illustrative embodiment, device authentication logic 520 generates several synthetic device attributes, allowing different synthetic device attributes to be selected at random for different authentications. In each iteration of the loop of steps 902-912, the particular synthetic device attribute generated by device authentication logic 520 is sometimes referred to as “the subject synthetic device attribute”.

In step 904, device authentication logic 520 generates a cryptographic key using pseudo-random number generation techniques.

In step 906, device authentication logic 520 generates a cryptographic salt from selected portions of the attribute data received in step 208 (FIG. 2).

In step 908 (FIG. 9), device authentication logic 520 generates synthetic attribute data for the value of the subject synthetic device attribute using a cryptographic hash function and the cryptographic key generated in step 904 and the cryptographic salt generated in step 906. Cryptographic hash functions, keys, and salts are known and are not described herein.

In step 910, device authentication logic 520 stores the subject synthetic attribute data as a newly added device attribute 802 (FIG. 8) of the known device data 800 for device 102. In addition, device authentication logic 520 stores a synthetic key generation record 808 that represents the manner in which the subject synthetic attribute data is generated. In particular, device authentication logic 520 stores with name 810 (FIG. 8) of the subject synthetic attribute data (i) the synthetic key generated in step 904 (FIG. 9) as key 812 (FIG. 8) and, (ii) as salt specification 814, stores data representing the selected portions of the received attribute data from which the cryptographic salt was generated in step 906 (FIG. 9). If necessary in the future, device authentication logic 520 can re-generate the subject synthetic attribute data using synthetic key generation record 808 (FIG. 8).

After step 910 (FIG. 9), processing by device authentication logic 520 transfers through next step 912 to loop step 902 to process the next synthetic device attribute according to the loop of steps 902-912. Once all synthetic device attributes have been processed according to the loop of steps 902-912, processing by device authentication logic 520 according to logic flow diagram 210, and therefore step 210 (FIG. 2) completes.

In this illustrative embodiment, device authentication logic 520 only creates synthetic device attributes if device authentication logic 520 determines that the attribute data received in step 208 (FIG. 8) is unlikely to result in a globally unique identifier for device 102.

As noted herein, the IOS operating system of Apple Computer limits access to hardware and system configuration attributes reducing the likelihood that the available hardware and system configuration attributes can provide a globally unique identifier for such devices. However, devices running the IOS operating system can be modified in a manner sometimes referred to as “jailbreaking” to gain access to a much wider variety of hardware and system configuration attributes of the devices.

In this embodiment, web browser plug-in 622 and/or DDK generator 640 of device 102 detects whether device 102 has been modified in this way and includes data indicating such modification in the attribute data sent in step 208. If device authentication logic 520 determines that device 102 has been so modified, either by data so indicating in the attribute data or by the presence of attributes in the attribute data that would otherwise not be available, device authentication logic 520 does not create synthetic device attributes for device 102 and uses only conventional DDK-based device authentication.

In alternative embodiment, device authentication logic 520 creates synthetic device attributes for all devices.

After step 210, device authentication server 108 has created and stored a known device record 800 for device 102 in known device data 530 (FIG. 5) and device 102 can be subsequently recognized by device authentication server 108. In step 212 (FIG. 2), device authentication server 108 sends the synthetic attribute data to device 102. In this illustrative embodiment, device authentication server 108 sends the synthetic attribute data itself as name/value pairs. In an alternative embodiment, device authentication server 108 sends synthetic key generation records 808 (FIG. 8) so that device 102 can generate synthetic attribute data when needed in the manner described above with respect to logic flow diagram 210 (FIG. 9).

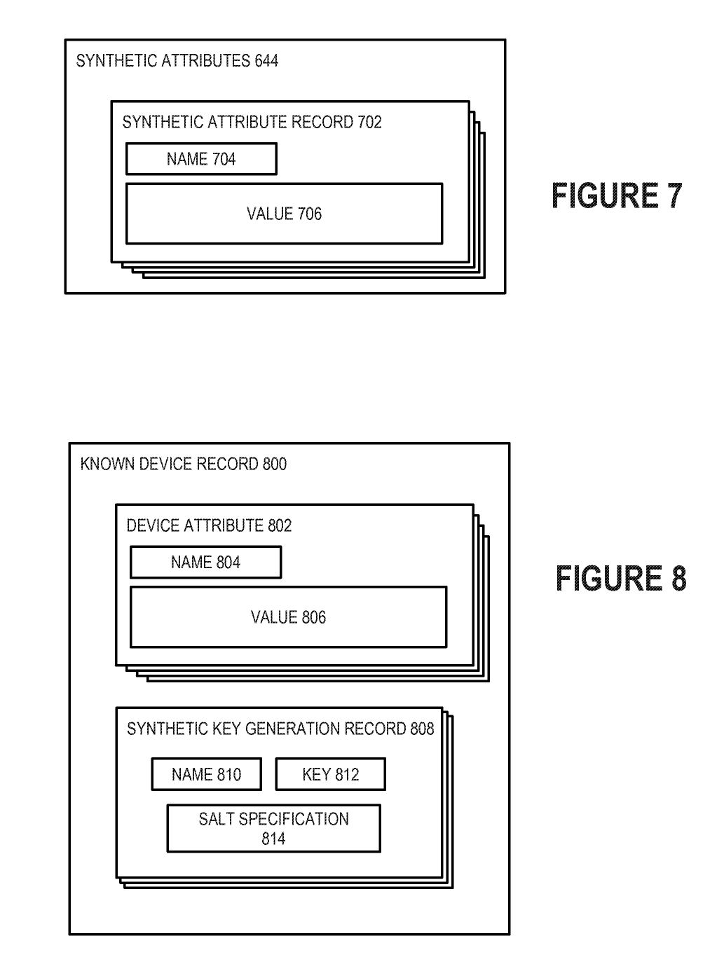

In step 214 (FIG. 2), device 102 stores the synthetic attribute data as synthetic attributes 644 (FIG. 6). In the embodiment in which device authentication server 108 sends the synthetic attribute data itself, synthetic attributes 644 are stored as shown in FIG. 7. Each of synthetic attribute records 702 includes a name 704 and a value 706 that correspond to name 804 (FIG. 8) and value 806, respectively, of the synthetic attribute data sent by device authentication server 108. In the embodiment in which device authentication server 108 sends synthetic key generation records 808 (FIG. 8), device 102 stores the received synthetic key generation records in synthetic attributes 644 (FIG. 6).

After step 214 (FIG. 2), processing according to transaction flow diagram 200 completes and device 102 is registered for subsequent authentication with device authentication server 108 and device includes synthetic attributes 644 (FIG. 6) that can be used to distinguish device 102 from otherwise indistinguishable devices. For security reasons, it is preferred that synthetic attributes 644 are stored in a manner than prevent access by other processes. Some devices provide a particularly secure mechanism for persistent storage of synthetic attributes. For example, devices that operate with the IOS operating system of Apple Computer provide a “UI Pasteboard” mechanism in which synthetic attributes 644 can be stored and hidden from any processes that do not know the precise file path at which synthetic attributes 644 are stored.

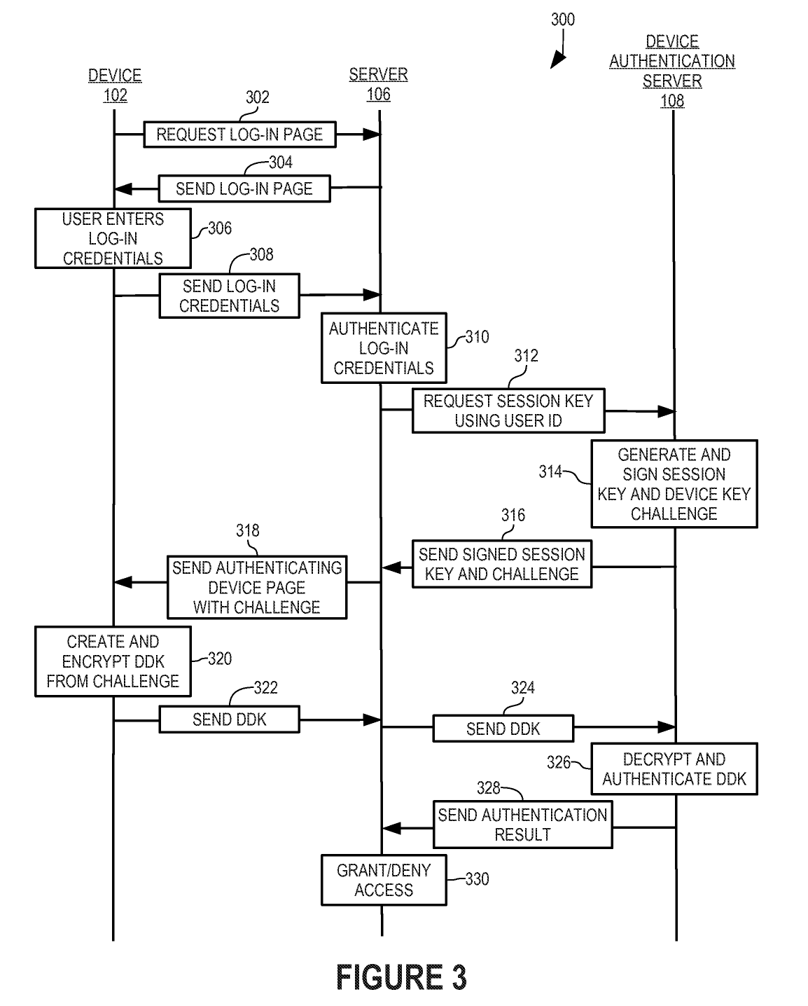

Transaction flow diagram 300 (FIG. 3) illustrates the use of device authentication server 108 to authenticate a user of device 102 and device 102 itself with server 106.

In step 302, device 102 sends a request for a log-in web page to server computer 106 by which the user can authenticate herself. The request can be in the form of a URL specified by the user of device 102 using web browser 620 (FIG. 6) and conventional user interface techniques involving physical manipulation of user input devices 608.

In step 304 (FIG. 3), server 106 sends the web page that is identified by the request received in step 302. The web page sent to device 102 includes content that defines a user interface by which the user of device 102 can enter her authentication credentials, such as a user name and associated password for example.

In step 306, web browser 620 (FIG. 6) of device 102 executes the user interface and the user of device 102 enters her authentication credentials, e.g., by conventional user interface techniques involving physical manipulation of user input devices 608.

In step 308 (FIG. 3), device 102 sends the entered authentication credentials to server 106. Server 106 authenticates the authentication credentials in step 310, e.g., by comparison to previously registered credentials of known users. If the credentials are not authenticated, processing according to transaction flow diagram 300 terminates and the user of device 102 is denied access to services provided by server 106. Conversely, if server 106 determines that the received credentials are authentic, processing according to transaction flow diagram 300 continues.

In step 312 (FIG. 3), server 106 sends a request to device authentication server 108 for a session key using a user identifier from the received authentication credentials. In embodiments in which each user has at most one associated device, the user identifier also identifies device 102. In alternative embodiments, the request can include data identifying device 102 as well.

In response to the request, device authentication server 108 generates and cryptographically signs a session key. Session keys and their generation are known and are not described herein. In addition, device authentication server 108 creates a device key challenge and encrypts the device key challenge using a public key of device 102 and PKI. In step 316, device authentication server 108 sends the signed session key and the encrypted device key challenge to server 106.

In step 318, server 106 sends a “device authenticating” page to device 102 along with the device key challenge. The “device authenticating” page includes content that provides a message to the user of device 102 that authentication of device 102 is underway.

The device key challenge causes web browser 620 (FIG. 6) of device 102 to generate a device identifier, sometimes referred to herein as a dynamic device key (DDK) for device 102, e.g., dynamic device key 642. In one embodiment, a web browser plug-in 622 is installed in client device 102 and, invoked by web browser 620, processes the content of the web page to generate the DDK. In other embodiments, DDK 642 of device 102 can be generated by other forms of logic of device 102, such as DDK generator 640 installed in device 102.

The device key challenge specifies the manner in which DDK 642 is to be generated from hardware and system configuration attributes of device 102. In particular, the device key challenge specifies items of information to be collected from hardware and system configuration attributes of device 102 and the manner in which those items of information are to be combined to form DDK 642. The generation of a dynamic device key from a device key challenge is described more completely in U.S. Patent Application Publication US 2011/0009092 and that description is incorporated herein.

However, in this embodiment, the hardware and system configuration attributes from which device 102 can be directed to form DDK 642 includes synthetic attributes 644. Thus, similar devices, particularly similar devices with limited access to hardware and system configuration attributes can be readily distinguished from one another, making device authentication as described herein much more robust.

Once DDK 642 is generated according to the received device key challenge, device 102 encrypts DDK 642 using a public key of device authentication server 108 and PKI.

In step 322 (FIG. 3), device 102 sends the encrypted dynamic device key to server 106, and server 106 sends the encrypted dynamic device key to device authentication server 108 in step 324.

In step 326, device authentication server 108 decrypts and authenticates the received DDK. To authenticate the received DDK, device authentication logic 520 (FIG. 5) compares the DDK of device 102 received in step 324 to DDKs of known devices. To compare the received DDK to DDKs of known devices, device authentication logic 520 applies the device key challenge generated in step 314 (FIG. 3) and sent in step 316 to known device records such as known device record 800 (FIG. 8).

In one embodiment, each of the known device records are each associated with a user, and device authentication logic 520 (FIG. 5) only generates and compares DDKs of known device records associate with the user whose identifier is received in step 312 (FIG. 3). In an alternative embodiment, device authentication logic 520 (FIG. 5) generates and compares DDKs of all known device records to identify device 102 without regard to the identity of the user of device 102.

In one embodiment, a match is determined by comparison of the received DDK to the known DDK. When the received DDK matches a DDK generated from a known device record 800 (FIG. 8), device authentication logic 520 (FIG. 5) has positively identified device 102 as the device associated with known device record 800. Otherwise, authentication of device 102 has failed.

In this illustrative embodiment, the comparison is more rigorous. In particular, the challenge generated in step 314 (FIG. 3) includes requests for all of the parts of the attribute data of device 102 used to generate the cryptographic salt for at least one synthetic device attribute in step 906 (FIG. 9). Device authentication logic 520 (FIG. 5) parse these parts of the attribute data from the received DDK and verifies that parts accurately reproduce one or more of the synthetic device attributes of device 102. A mismatch of the DDKs or failure to accurately reproduce a synthetic device attribute of device 102 results in a failure to authenticate device 102.

In step 328 (FIG. 3), device authentication server 108 sends data representing the result of authentication of device 102 to server 106.

In step 330, server 106 determines whether to continue to interact with device 102 and in what manner according to the device authentication results received in step 328.

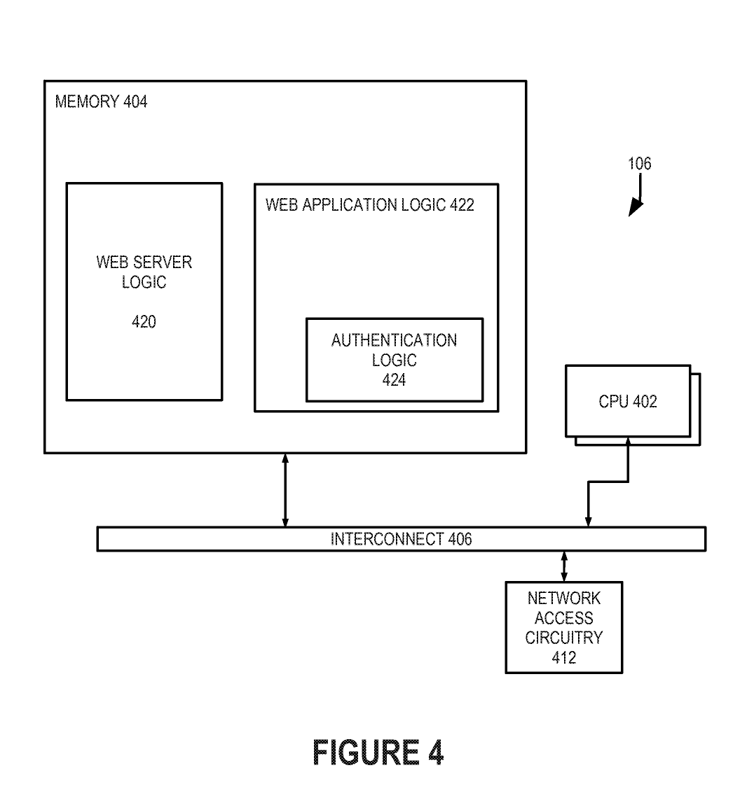

Server 106 is shown in greater detail in FIG. 4. Server 106 includes one or more microprocessors 402 (collectively referred to as CPU 402) that retrieve data and/or instructions from memory 404 and execute retrieved instructions in a conventional manner. Memory 404 can include generally any computer-readable medium including, for example, persistent memory such as magnetic and/or optical disks, ROM, and PROM and volatile memory such as RAM.

CPU 402 and memory 404 are connected to one another through a conventional interconnect 406, which is a bus in this illustrative embodiment and which connects CPU 402 and memory 404 to network access circuitry 412. Network access circuitry 412 sends and receives data through computer networks such as wide area network 104 (FIG. 1).

A number of components of server 106 are stored in memory 404. In particular, web server logic 420 and web application logic 422, including authentication logic 424, are all or part of one or more computer processes executing within CPU 402 from memory 404 in this illustrative embodiment but can also be implemented using digital logic circuitry.

Web server logic 420 is a conventional web server. Web application logic 422 is content that defines one or more pages of a web site and is served by web server logic 420 to client devices such as device 102. Authentication logic 424 is a part of web application logic 422 that causes client devices and their users to authenticate themselves in the manner described above.

Device authentication server 108 is shown in greater detail in FIG. 5. Device authentication server 108 includes one or more microprocessors 502 (collectively referred to as CPU 502), memory 504, a conventional interconnect 506, and network access circuitry 512, which are directly analogous to CPU 402 (FIG. 4), memory 404, conventional interconnect 406, and network access circuitry 412, respectively.

A number of components of device authentication server 108 (FIG. 5) are stored in memory 504. In particular, device authentication logic 520 is all or part of one or more computer processes executing within CPU 502 from memory 504 in this illustrative embodiment but can also be implemented using digital logic circuitry. Known device data 530 is data stored persistently in memory 504. In this illustrative embodiment, known device data 530 is organized as all or part of one or more databases.

Device 102 is a personal computing device and is shown in greater detail in FIG. 6. Device 102 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional interconnect 606, which is a bus in this illustrative embodiment and which connects CPU 602 and memory 604 to one or more input devices 608, output devices 610, and network access circuitry 612. Input devices 608 can include, for example, a keyboard, a keypad, a touch-sensitive screen, a mouse, a microphone, and one or more cameras. Output devices 610 can include, for example, a display—such as a liquid crystal display (LCD)—and one or more loudspeakers. Network access circuitry 612 sends and receives data through computer networks such as wide area network 104 (FIG. 1).

A number of components of device 102 are stored in memory 604. In particular, web browser 620 is all or part of one or more computer processes executing within CPU 602 from memory 604 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 622 are each all or part of one or more computer processes that cooperate with web browser 620 to augment the behavior of web browser 620. The manner in which behavior of a web browser is augmented by web browser plug-ins is conventional and known and is not described herein.

Operating system 630 is all or part of one or more computer processes executing within CPU 602 from memory 604 in this illustrative embodiment but can also be implemented using digital logic circuitry. An operating system (OS) is a set of programs that manage computer hardware resources and provide common services for application software such as web browser 620, web browser plug-ins 622, and DDK generator 640.

DDK generator 640 is all or part of one or more computer processes executing within CPU 602 from memory 604 in this illustrative embodiment but can also be implemented using digital logic circuitry. DDK generator 640 facilitates authentication of device 102 in the manner described above.

Dynamic device key 642 and synthetic attributes 644 are data stored persistently in memory 604 and can each be organized as all or part of one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for identifying a remotely located device, the method comprising:
receiving attribute data from the device, wherein the attribute data includes data representing one or more hardware configuration characteristics of the device;
generating one or more items of device-specific data from the attribute data, wherein the items of device-specific data are specific to the device and distinct among corresponding items of device-specific data specific to other devices;
sending the items of device-specific data to the device for persistent storage in the device;
requesting one or more items of test attribute data from the device, wherein items of test attribute data includes at least part of at least one of the more items of device-specific data and at least part of the attribute data;
receiving the test attribute data from the device;
determining that the items of test attribute data match corresponding items of the attribute data and of the device-specific data; and
recognizing the device as authentic in response to the determining.

2. The method of claim 1 wherein generating comprises:
combing pseudo-randomly generated data with at least part of the attribute data using a cryptographic hash function.

3. The method of claim 2 wherein requesting comprises:
sending attribute gathering logic to the device, wherein the attribute gathering logic causes the device to gather data representing at least part of the hardware configuration characteristics of the device and at least part of at least one of the more items of device-specific data to form the test attribute data.

4. The method of claim 3 wherein the attribute gathering logic also causes the device to apply a cryptographic hash function to the data representing at least part of the hardware configuration characteristics of the device and at least part of at least one of the more items of device-specific data to form the test attribute data as a cryptographic hash; and
wherein determining comprises applying the cryptographic hash function to corresponding portions of the attribute data to form a test cryptographic hash and comparing the cryptographic hash to the test cryptographic hash.

5. The method of claim 4 wherein sending the items of device-specific data to the device comprises sending device-specific data generation information that enables the device to generate the device-specific data from the one or more hardware configuration characteristics of the device.

6. The method of claim 3 wherein sending the items of device-specific data to the device comprises sending device-specific data generation information that enables the device to generate the device-specific data from the one or more hardware configuration characteristics of the device.

7. The method of claim 2 wherein sending the items of device-specific data to the device comprises sending device-specific data generation information that enables the device to generate the device-specific data from the one or more hardware configuration characteristics of the device.

8. The method of claim 1 wherein requesting comprises:
sending attribute gathering logic to the device, wherein the attribute gathering logic causes the device to gather data representing at least part of the hardware configuration characteristics of the device and at least part of at least one of the more items of device-specific data to form the test attribute data.

9. The method of claim 8 wherein sending the items of device-specific data to the device comprises sending device-specific data generation information that enables the device to generate the device-specific data from the one or more hardware configuration characteristics of the device.

10. The method of claim 8 wherein the attribute gathering logic also causes the device to apply a cryptographic hash function to the data representing at least part of the hardware configuration characteristics of the device and at least part of at least one of the more items of device-specific data to form the test attribute data as a cryptographic hash; and
wherein determining comprises applying the cryptographic hash function to corresponding portions of the attribute data to form a test cryptographic hash and comparing the cryptographic hash to the test cryptographic hash.

11. The method of claim 10 wherein sending the items of device-specific data to the device comprises sending device-specific data generation information that enables the device to generate the device-specific data from the one or more hardware configuration characteristics of the device.

12. The method of claim 1 wherein sending the items of device-specific data to the device comprises sending device-specific data generation information that enables the device to generate the device-specific data from the one or more hardware configuration characteristics of the device.
